(19) United States
(12) Patent Application Publication
(10) Pub. No.: US 2025/0060722 A1
(43) Pub. Date: Feb. 20, 2025

(54) CONTROL SYSTEM, PROGRAMMABLE LOGIC CONTROLLER, AND RECORDING MEDIUM

(71) Applicant: Mitsubishi Electric Corporation, Tokyo (JP)

(72) Inventors: Keita YAMAZAKI, Nagoya-shi, Aichi (JP); Eitaro HIOKI, Nagoya-shi, Aichi (JP)

(73) Assignee: Mitsubishi Electric Corporation, Tokyo (JP)

(21) Appl. No.: 18/724,208

(22) PCT Filed: Jun. 15, 2022
(86) PCT No.: PCT/JP2022/024002

§ 371 Date: Jun. 26, 2024

(51) Int. Cl. G05B 19/05

(52) U.S. Cl. CPC G05B 19/05; G05B 2219/13082

(57) ABSTRACT

A control system includes a programmable logic controller to execute at least one program and a programming support device to create the program. In the control system, an end process time measurer measures an execution time of an end process performed after execution of the program in a single scanning process, and a display displays the execution time of the end process on a screen in the programming support device.

### TECHNICAL FIELD

The present disclosure relates to a control system, a programmable logic controller, a visualization method, and a program.

### BACKGROUND ART

A technique is known for displaying the execution time of a program in order to visualize the performance of the program being executed by a programmable logic controller (PLC). For example, Patent Literature 1 describes a technique for outputting, onto a monitor of a programming console, the execution time of a subroutine executed by the PLC.

### CITATION LIST

### Patent Literature

Patent Literature 1: Unexamined Japanese Patent Application Publication No. H7-121212

### SUMMARY OF INVENTION

### Technical Problem

Typically, each time execution of the program is completed, the PLC performs an end process including checking the operation of the PLC and logging for collecting device data. The PLC then repeatedly performs a single scanning process including a program execution process and an end process. Such a technique described in Patent Literature 1 above does not measure the execution time of the end process and cannot refer to the execution time of the end process, and thus may not easily allow identification of the cause of a trouble that may occur in the end process.

Under such circumstances, one or more aspects of the present disclosure are directed to a control system, a programmable logic controller, a visualization method, and a program for allowing reference to the execution time of an end process performed each time execution of the program is completed.

### Solution to Problem

To achieve the above objective, a control system according to an aspect of the present disclosure includes a programmable logic controller to execute at least one program, a programming support device to create the at least one program, end process time measurement means for measuring an execution time of an end process performed each time execution of each of the at least one program is completed, and display means for displaying the execution time of the end process on a screen included in the programming support device.

### Advantageous Effects of Invention

The control system, the programmable logic controller, the visualization method, and the program according to the above aspect of the present disclosure allow reference to the execution time of the end process performed each time execution of the program is completed.

### BRIEF DESCRIPTION OF DRAWINGS

FIG. 1 is a functional block diagram of a control system according to an embodiment;

FIG. 2 is a block diagram of a programmable logic controller (PLC) according to the embodiment, illustrating the hardware configuration;

FIG. 3 is a block diagram of a programming support device according to the embodiment, illustrating the hardware configuration;

FIG. 4 is a diagram describing a storage area storing monitor information according to the embodiment;

FIG. 5 is a diagram illustrating example monitor information displayed on a screen according to the embodiment;

FIG. 6 is a diagram illustrating example monitor information displayed on the screen according to the embodiment;

FIG. 7 is a flowchart of a measurement process according to the embodiment;

FIG. 8 is a sequence diagram illustrating processing performed between the PLC and the programming support device according to the embodiment; and

FIG. 9 is a diagram illustrating example monitor information displayed on the screen in a modification.

### DESCRIPTION OF EMBODIMENTS

### Embodiments

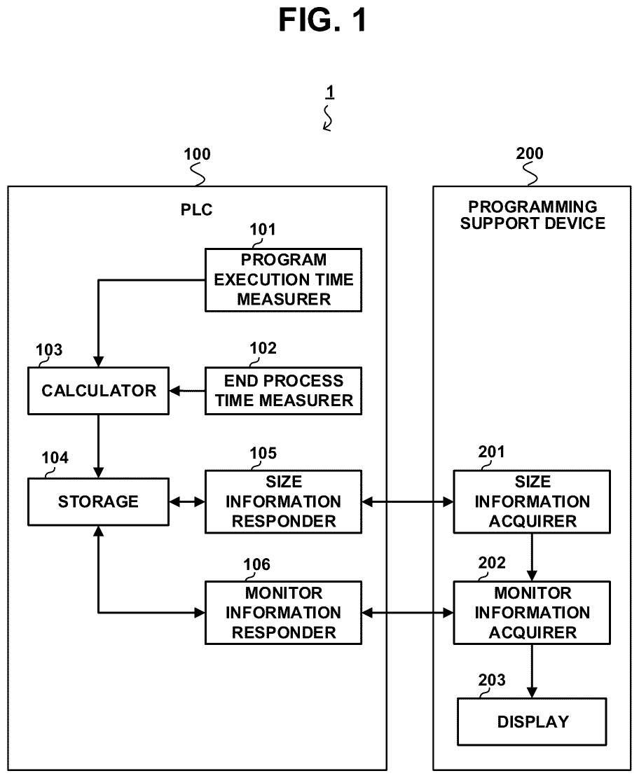

A control system 1 according to an embodiment is a system for controlling factory automation (FA) devices (not illustrated) that are connected to a programmable logic controller (PLC). As illustrated in FIG. 1, the control system 1 includes a PLC 100 and a programming support device 200. The PLC 100 is connected to the programming support device 200 with a network cable (not illustrated) or wirelessly.

The PLC 100 controls the FA devices and executes a program created by a user. The PLC 100 according to the present embodiment includes a multi-core processor including multiple processor cores, and executes the program with the multi-core processor. The processor cores included in the multi-core processor are hereafter simply referred to as cores.

The programming support device 200 is used to create a program to be executed by the PLC 100. The programming support device 200 includes a programming tool being installed. The programming tool is an application for creating a program to be executed by the PLC 100. The user uses the programming tool to create a program to be executed by the PLC 100. The programming tool can also visualize the performance of the PLC 100 executing the program. The user uses the programming tool to check the performance of the PLC 100. The performance of the PLC 100 is indicated using indicators including scan time (described later).

The PLC 100 performs an end process after executing the program created by the user. The end process is performed each time execution of the program is completed. The end process includes various processes. Content of the end process may be set automatically when the program is created, or may be set by the user creating the program in the programming support device 200. The end process includes, for example, checking the operation of the PLC 100, logging to collect device data about the PLC, reading and writing data from an external device, and resetting a watchdog timer.

When a program is executed by each of the multiple cores, the end process performed by each core is to be started at the same time. Thus, to align the starting time of the end process with the core having the longest program execution time, the other cores each perform a standby process to wait until the core with the longest program execution time completes the program execution. The core with the longest program execution time does not perform the standby process.

Each processor core in the PLC 100 repeatedly performs a single scanning process including a program execution process, a standby process, and an end process. The time taken to perform the single scanning process is referred to as a scan time. The scan time is determined by the sum of the execution times of the program, the standby process, and the end process. The execution time of the standby process is hereafter referred to as a wait time. The control system 1 according to the present embodiment visualizes the scan time as well as the details of the scan time.

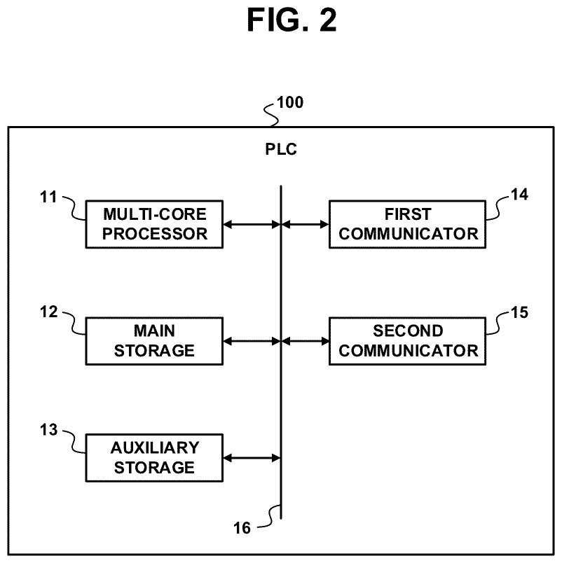

FIG. 2 illustrates the hardware configuration of the PLC 100.

The PLC 100 includes a multi-core processor 11 that performs various processes, a main storage 12 used as a work area for the multi-core processor 11, an auxiliary storage 13 that stores various sets of data used for processing performed by the multi-core processor 11, a first communicator 14 that communicates with external devices including the programming support device 200, and a second communicator 15 that communicates with the FA devices. The main storage 12, the auxiliary storage 13, the first communicator 14, and the second communicator 15 are all connected to the multi-core processor 11 with a bus 16.

The multi-core processor 11 is a central processing unit (CPU) with multiple cores. The multi-core processor 11 implements various functions of the PLC 100 by executing a program stored in the auxiliary storage 13.

The main storage 12 includes a random-access memory (RAM). The program is loaded into the main storage 12 from the auxiliary storage 13. The main storage 12 is used as the work area for the multi-core processor 11.

The auxiliary storage 13 includes a nonvolatile memory such as an electrically erasable programmable read-only memory (EEPROM). In addition to the program, the auxiliary storage 13 stores various sets of data used for processing performed by the multi-core processor 11. The auxiliary storage 13 provides data to be used by the multi-core processor 11 to the multi-core processor 11 as instructed by the multi-core processor 11, and stores data provided by the multi-core processor 11.

The first communicator 14 includes network interface circuitry for communicating with the external devices including the programming support device 200. The first communicator 14 receives signals from the external devices and outputs data indicated by the signals to the multi-core processor 11. The first communicator 14 transmits signals indicating data output from the multi-core processor 11 to the external devices.

The second communicator 15 includes network interface circuitry for communicating with the FA devices that are controlled by the PLC 100. The second communicator 15 receives signals from the FA devices and outputs data indicated by the signals to the multi-core processor 11. The second communicator 15 transmits signals indicating data output from the multi-core processor 11 to the FA devices.

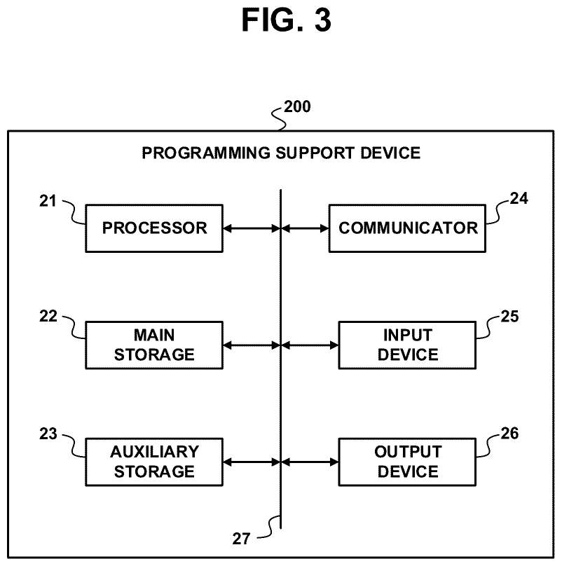

FIG. 3 illustrates the hardware configuration of the programming support device 200.

The programming support device 200 includes a processor 21 that performs various processes, a main storage 22 used as a work area for the processor 21, an auxiliary storage 23 that stores various sets of data used for processing performed by the processor 21, a communicator 24 for communicating with the external devices including the PLC 100, an input device 25 for acquiring input information, and an output device 26 for presenting various sets of information. The main storage 22, the auxiliary storage 23, the communicator 24, the input device 25, and the output device 26 are all connected to the processor 21 with a bus 27.

The processor 21 includes a CPU. The processor 21 implements various functions of the programming support device 200 by executing a program stored in the auxiliary storage 23.

The main storage 22 includes a RAM. The program is loaded into the main storage 22 from the auxiliary storage 23. The main storage 22 is used as the work area for the processor 21.

The auxiliary storage 23 includes a nonvolatile memory such as an

EEPROM. In addition to the program, the auxiliary storage 23 stores various sets of data used for processing performed by the processor 21. The auxiliary storage 23 provides data to be used by the processor 21 to the processor 21 as instructed by the processor 21, and stores data provided by the processor 21.

The communicator 24 includes network interface circuitry for communicating with the external devices including the PLC 100. The communicator 24 receives signals from the external devices and outputs data indicated by the signals to the processor 21. The communicator 24 transmits signals indicating data output from the processor 21 to the external devices.

The input device 25 includes an input device such as an input key or a pointing device. The input device 25 receives information input by the user of the programming support device 200 and provides the acquired information to the processor

The output device 26 includes an output device such as a liquid crystal display (LCD) or a speaker. The output device 26 may include a touchscreen integral with the pointing device as the input device 25. The output device 26 presents the various sets of information to the user as instructed by the processor 21.

The functions of the PLC 100 and the programming support device 200 are described below. In the example below, the multi-core processor 11 has four cores, or specifically, “Core 1”, “Core 2”, “Core 3”, and “Core 4”. The user-created programs are

“PRG 1”, “PRG 2”, and “PRG 3”. “PRG 1” and “PRG 2” are executed by “Core 1”, whereas “PRG3” is executed by “Core 2”. “Core 1” performs an end process for “FUNC 1” and “FUNC 2” after executing “PRG 1” and “PRG 2”, whereas “Core 2” performs an end process for “FUNC 3” after executing “PRG 3”.

The functions of the PLC 100 in FIG. 1 are described below first. The PLC 100 includes, as functional components, a program execution time measurer 101 that measures the program execution time, an end process time measurer 102 that measures the execution time of the end process, a calculator 103 that calculates the wait time, a storage 104 storing monitor information (described later), a size information responder 105 that transmits a size information response including information about the size of the monitor information to the programming support device 200, a monitor information responder 106 that transmits a monitor information response including the monitor information to the programming support device 200.

The program execution time measurer 101 measures the execution time of a program executed by each of the multiple cores. The program execution time measurer 101 is implemented by the multi-core processor 11. The program execution time measurer 101 is an example of program execution time measurement means.

For example, the program execution time measurer 101 measures the execution times of “PRG 1” and “PRG 2” executed by “Core 1” as “3.000 [ms]” and “7.000 [ms]”, and measures the execution time of “PRG 3” executed by “Core 2” as “4.600 [ms]”.

The end process time measurer 102 measures the execution time of the end process performed by each of the multiple cores. The end process time measurer 102 is implemented by the multi-core processor 11. The end process time measurer 102 is an example of end process time measurement means.

For example, the end process time measurer 102 measures the execution times of “FUNC 1” and “FUNC 2” executed by “Core 1” as “5.000 [ms]” and “3.000 [ms]”, and measures the execution time of “FUNC 3” executed by “Core 2” as “8.000 [ms]”.

The calculator 103 calculates the wait time taken to cause the end process performed by each of the multiple cores to start at the same time. The calculator 103 stores information about the program execution time, the execution time of the end process, and the wait time into the storage 104. The calculator 103 is implemented by the multi-core processor 11. The calculator 103 is an example of calculation means.

For example, the calculator 103 compares the execution times of programs executed by the cores and calculates the wait time by subtracting, from the execution time for a core with the longest measured program execution time, the execution time of the program executed by each of the other cores. In this case, when multiple program execution times are measured for one core, the sum of the program execution times is used to compare the program execution times for the cores. With the execution times of multiple programs measured for “Core 1”, the calculator 103 determines the sum of the program execution times as “10.000 [ms] (=3.000 [ms]+7.000 [ms])”, and compares the value with the program execution time “4.600 [ms]” for “Core 2”. The calculator 103 then subtracts “4.600 [ms]” from “10.000 [ms]” that is the sum of the program execution times for “Core 1”, and calculates “5.400 [ms]” as the wait time for “Core 2”.

The calculator 103 then stores, into the storage 104, the execution times of “PRG 1” and “PRG 2” as “3.000 [ms]” and “7.000 [ms]” and the execution times of “FUNC 1” and “FUNC 2” as “5.000 [ms]” and “3.000 [ms]” for “Core 1”, and the execution time of “PRG 3” as “4.600 [ms]”, the execution time of “FUNC 3” as “8.000 [ms]”, and the wait time as “5.400 [ms]” for “Core 2”.

The calculator 103 also calculates statistical information about the program execution time, the execution time of the end process, and the wait time for each core, and stores the statistical information into the storage 104. The statistical information is, for example, a maximum value, a minimum value, or a moving average. The calculator 103 measures a cumulative program execution count in each core and stores information about the cumulative program execution count into the storage 104.

The storage 104 stores the monitor information including information about the program execution time, the execution time of the end process, the wait time, and the cumulative program execution count. The monitor information is to be displayed on the screen in the programming support device 200. The storage 104 is implemented by the auxiliary storage 13. The storage 104 is an example of storage means.

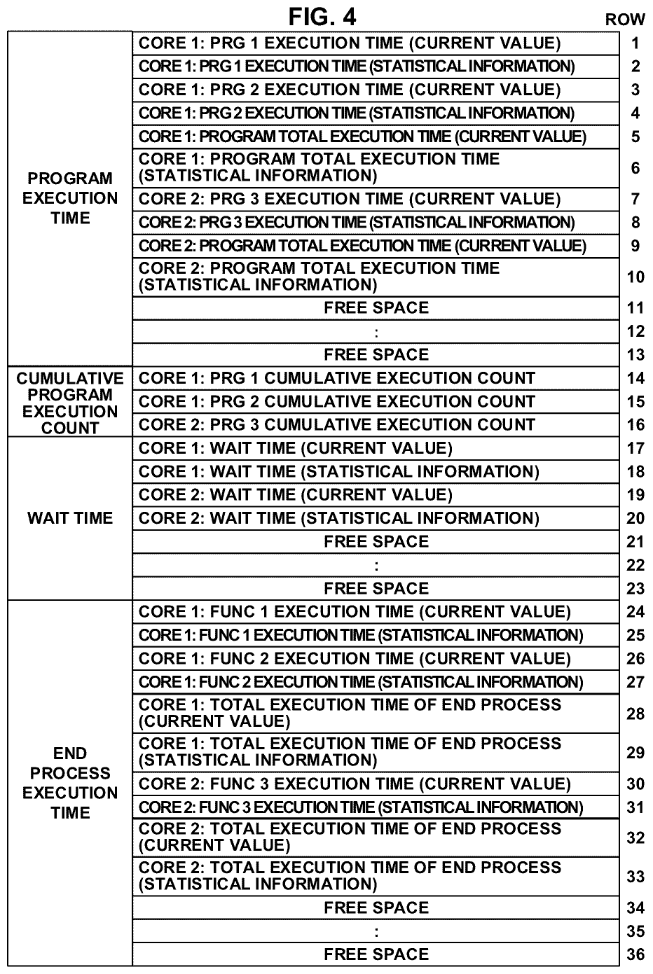

FIG. 4 is a schematic diagram of the areas of the storage 104 storing the monitor information. The storage 104 includes areas for storing information about multiple items included in the monitor information. The calculator 103 compares information of items such as the measured execution time and the calculated wait time with the information stored in the areas, corresponding to the respective items, to update the monitor information. The monitor information in FIG. 4 includes information about the program execution time, the cumulative program execution count, the wait time, and the execution time of the end process for each of the multiple cores. The program execution time, the cumulative program execution count, and the execution time of the end process each include the current value indicating the latest value and the statistical information.

In response to a size information request transmitted from the programming support device 200, the size information responder 105 determines the size of the monitor information stored in the storage 104, and transmits the size information response including the size information indicating the determined size to the programming support device 200. The size information responder 105 is implemented by the multi-core processor 11 and the first communicator 14. The size information responder 105 is an example of size information response means.

The size information request is a request transmitted from the programming support device 200 to acquire information about the size of monitor information. The information about the size of the monitor information indicates the size of the monitor information in the area of the storage 104 illustrated in FIG. 4 excluding a free space.

For example, when the size information responder 105 receives a size information request, the size information responder 105 calculates the size of the monitor information in the first to tenth rows, the fourteenth to twentieth rows, and the twenty-fourth to thirty-third rows in the areas of the storage 104 illustrated in FIG. 4, and transmits a size information response including the size information indicating the calculated size to the programming support device 200. The size determined is hereafter referred to as “X bytes”.

The monitor information responder 106 transmits a monitor information response including the monitor information stored in the storage 104 to the programming support device 200 in response to a monitor information request transmitted from the programming support device 200. The monitor information responder 106 divides the monitor information by including the monitor information of the size specified in the monitor information request in the monitor information response and transmits the divided monitor information to the programming support device 200. The monitor information responder 106 is implemented by the multi-core processor 11 and the first communicator 14. The monitor information responder 106 is an example of monitor information response means.

The monitor information request is transmitted from the programming support device 200 to acquire monitor information. The monitor information request specifies the size of the monitor information to be included in the monitor information response.

For example, when the monitor information responder 106 receives a monitor information request specifying a size of “0.6X bytes”, the monitor information responder 106 specifies a “0.6X bytes” portion of monitor information among “X bytes” of monitor information stored in the storage 104. For example, the monitor information responder 106 identifies monitor information with the size of “0.6X bytes” as information in the first to tenth rows and the fourteenth to twentieth rows in the areas of the storage 104 illustrated in FIG. 4. The monitor information responder 106 then transmits a monitor information response including the identified information to the programming support device 200. When the monitor information responder 106 receives a monitor information request specifying a size of “0.4X bytes”, the monitor information responder 106 transmits a monitor information response including monitor information stored in the storage 104 that has yet to be transmitted to the programming support device 200. In other words, the monitor information responder 106 transmits, to the programming support device 200, a monitor information response including information in the twenty-fourth to thirty-third rows in the areas of the storage 104 illustrated in FIG. 4.

The functions of the programming support device 200 is described below with reference to FIG. 1. The programming support device 200 includes, as functional components, a size information acquirer 201 for acquiring information about the size of monitor information, a monitor information acquirer 202 for acquiring monitor information, and a display 203 for displaying monitor information on a screen.

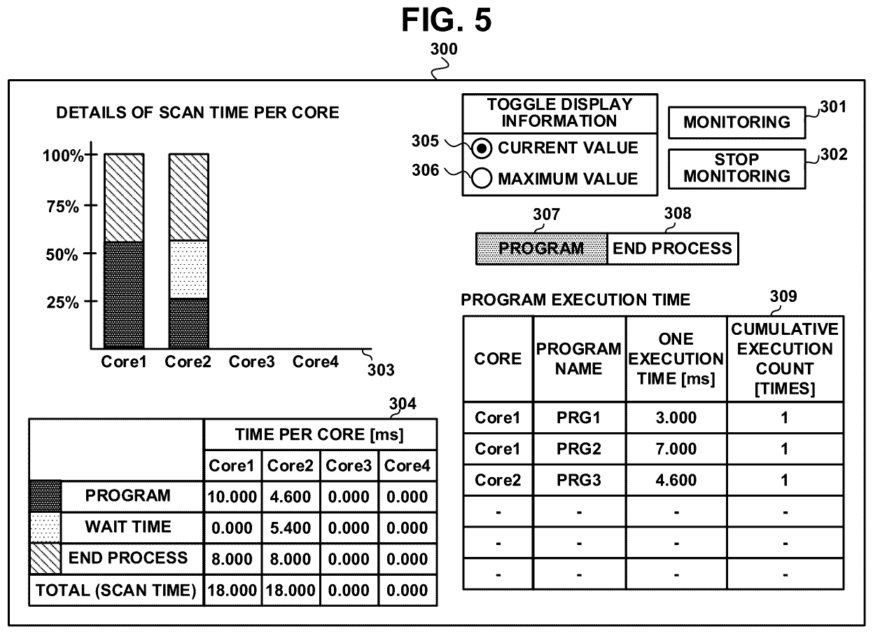

FIG. 5 illustrates monitor information displayed on the screen after being acquired by the programming support device 200. A window 300 is displayed on the screen using the functions of the programming tool installed in the programming support device 200.

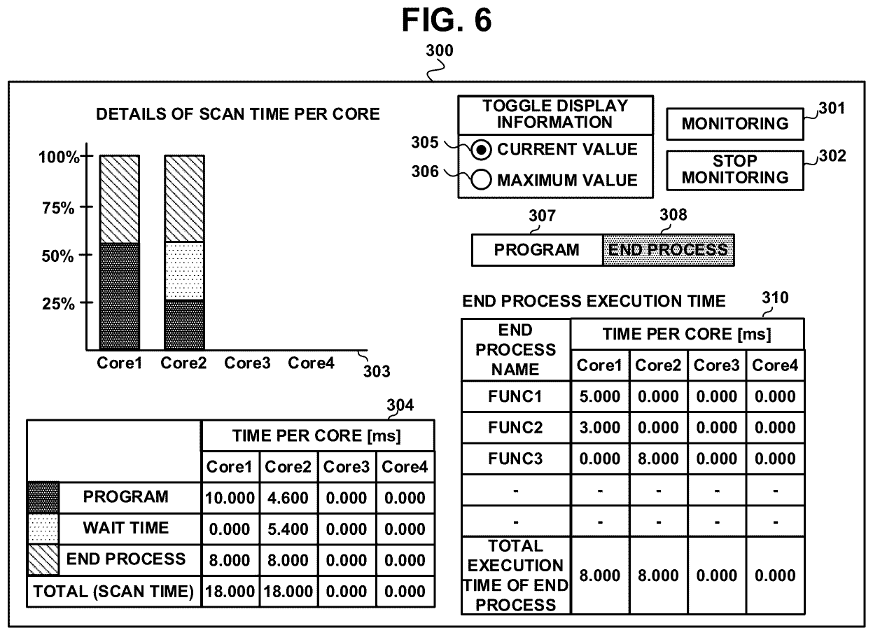

The window 300 in FIG. 5 includes a button 301 to start displaying monitor information, a button 302 to end displaying monitor information, a bar graph 303 to indicate the details of scan time for each core, a table 304 including the value of the scan time for each core, a radio button 305 to display the current value in a table 309 or a table 310, a radio button 306 to display the maximum value in the table 309 or the table 310, a button 307 to display the program execution time in the table 309, a button 308 to display the end program execution time in the table 310, and the table 309 including the program execution time. When the button 308 is selected on the window 300 in FIG. 5, the table 310 including the execution time of the end process is displayed in place of the table 309 including the program execution times as illustrated in FIG. 6.

The bar graph 303 indicates the proportion of the program execution time, the wait time, and the execution time of the end process to the overall scan time. The table 304 includes the program execution time, the wait time, the execution time of the end process, and the scan time for each core. The table 309 including program execution times in FIG. 5 indicates the execution time and the cumulative execution count for every program executed by each core. The table 310 including the execution time of the end process in FIG. 6 indicates the execution time for every end process performed by each core and the total execution time of the end process performed by each core.

The size information acquirer 201 transmits the size information request to the PLC 100 to acquire size information of the monitor information to be displayed on the screen. The size information acquirer 201 is implemented by the processor 21, the communicator 24, and the input device 25. The size information acquirer 201 is an example of size information acquisition means.

For example, when the user selects the button 301, the size information acquirer 201 transmits a size information request to the PLC 100 to acquire size information of the monitor information to be displayed on the window 300. The size information acquirer 201 then receives the size information response including the size information transmitted from the size information responder 105.

The monitor information acquirer 202 compares the size indicated by the size information included in the size information response transmitted from the size information responder 105 with the size of information that can be included in a single monitor information response and determines the number of times of transmission of monitor information requests to the PLC 100. The monitor information acquirer 202 then transmits the monitor information request to the PLC 100 by the determined number of times of transmission. The monitor information request is for acquiring monitor information to be displayed on the screen and specifies a size of the monitor information to be included in the monitor information response. The monitor information acquirer 202 is implemented by the processor 21 and the communicator 24. The monitor information acquirer 202 is an example of monitor information acquisition means.

The size of information that can be included in a single monitor information response is, for example, the size of information that can be included in one packet used in communication between the programming support device 200 and the PLC 100. Hereafter, the size of information that can be included in a single monitor information response is set to “0.6X bytes”. When the size information in the size information response indicates “X bytes”, the monitor information acquirer 202 determines that two packets are to be used to acquire the monitor information to be displayed on the screen, and determines that the number of times of transmission of monitor information is twice. The monitor information acquirer 202 transmits the monitor information request to the PLC 100 twice and acquires monitor information.

The monitor information acquirer 202 transmits, to the PLC 100, a first monitor information request specifying a size of “0.6X bytes”. The monitor information acquirer 202 then receives, from the monitor information responder 106, a monitor information response including “0.6X bytes” of monitor information. The monitor information response to the first monitor information request includes information in the first to tenth rows and the fourteenth to twentieth rows in the areas of the storage 104 illustrated in FIG. 4. When receiving the monitor information response to the first monitor information request, the monitor information acquirer 202 transmits a second monitor information request specifying a size of “0.4X bytes” to the PLC 100. The monitor information acquirer 202 then receives, from the monitor information responder 106, a monitor information response including the remaining monitor information. The monitor information response to the second monitor information request includes information in the twenty-fourth to thirty-third rows in the areas of the storage 104 illustrated in FIG. 4. In this manner, the monitor information acquirer 202 acquires the monitor information in the first to tenth rows, the fourteenth to twentieth rows, and the twenty-fourth to thirty-third rows in the areas of the storage 104 illustrated in FIG. 4.

The display 203 displays, for each of the multiple cores, the program execution time, the wait time, and the execution time of the end process on the screen in the programming support device 200. The display 203 is implemented by the processor 21 and the output device 26. The display 203 is an example of display means.

For example, the display 203 displays information including the program execution time, the wait time, and the execution time of the end process as in the window 300 in FIG. 5 based on the monitor information acquired by the monitor information acquirer 202.

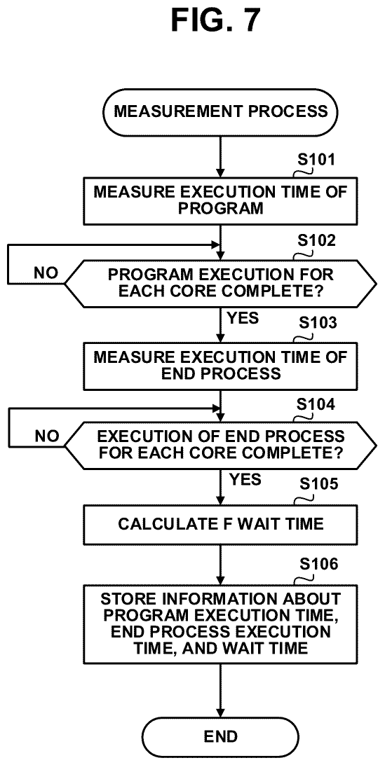

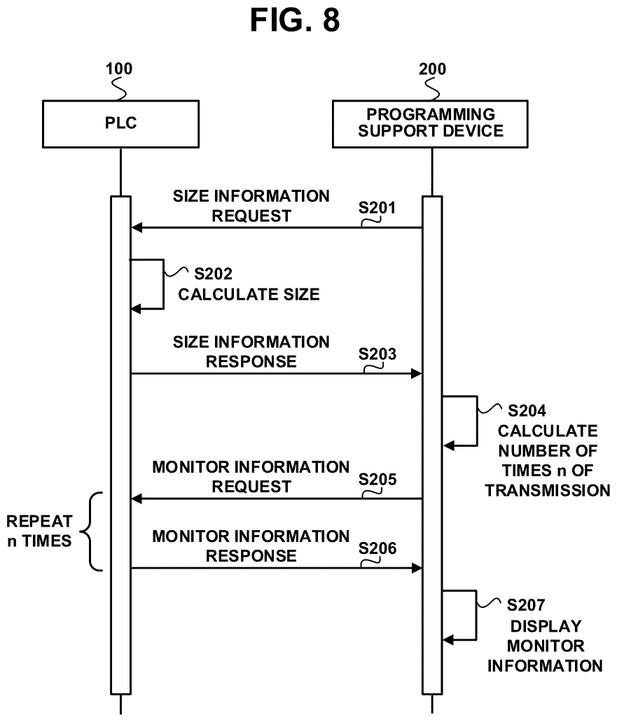

A method for visualizing the scan time according to the present embodiment is described below with reference to FIGS. 7 and 8.

FIG. 7 is a flowchart of a measurement process performed by the PLC 100 according to the present embodiment. The measurement process in FIG. 7 is, for example, a process performed when an operation to execute a program is input from the user.

The program execution time measurer 101 measures the execution time of the program executed by each of the multiple cores (step S101).

For example, the program execution time measurer 101 measures the execution time of “PRG 1” and “PRG 2” executed by “Core 1” and the execution time of “PRG 3” executed by “Core 2”.

The program execution time measurer 101 determines whether execution of the program for each core is complete (step S102). When the program execution time measurer 101 determines that program execution on each core is complete (Yes in step S102), the end process time measurer 102 measures the execution time of the end process performed by each of the multiple cores (step S103). In contrast, when determining that execution of the program performed by each core is incomplete (No in step S102), the end process time measurer 102 remains on standby.

For example, when “Core 1” completes execution of “PRG 1” and “PRG 2” and “Core 2” completes execution of “PRG 3”, the end process time measurer 102 measures the execution times of “FUNC 1” and “FUNC 2” executed by “Core 1”, and the execution time of “FUNC 3” executed by “Core 2”. In contrast, when execution of the program by “Core 1” or “Core 2” is incomplete, the end process time measurer 102 remains on standby.

The end process time measurer 102 determines whether execution of the end process by each core is complete (step S104). When the end process time measurer 102 determines that execution of the end process by each core is complete (Yes in step S104), the calculator 103 calculates the wait time for each core (step S105). In contrast, when determining that execution of the end process by each core is incomplete (No in step S104), the calculator 103 remains on standby.

For example, when “Core 1” completes execution of “FUNC 1” and “FUNC 2” and “Core 2” completes execution of “FUNC 3”, the calculator 103 calculates the wait time for “Core 2” as “5.400 [ms]”. In contrast, when determining that the end process performed by “Core 1” or “Core 2” is incomplete, the calculator 103 remains on standby.

The calculator 103 stores information about the program execution time, the execution time of the end process time, and the wait time into the storage 104 (step S106).

For example, the calculator 103 stores, into the storage 104, the execution times of “3.000 [ms]” of “PRG 1” and “7.000 [ms]” of “PRG 2”, and “5.000 [ms]” of “FUNC 1” and “3.000 [ms]” of “FUNC 2” for “Core 1”, and the execution times of “4.600 [ms]” of “PRG 3” and “8.000 [ms]” of “FUNC 3”, and the wait time of “5.400 [ms]” for “Core 2”.

FIG. 8 is a sequence diagram illustrating processes performed between the PLC 100 and the programming support device 200 in the present embodiment.

The size information acquirer 201 in the programming support device 200 transmits a size information request to the PLC 100 to acquire size information of the monitor information to be displayed on the screen (step S201).

For example, when the user selects the button 301, the size information acquirer 201 transmits a size information request to the PLC 100 to acquire size information of the monitor information to be displayed on the window 300.

When receiving the size information request from the size information acquirer 201, the size information responder 105 in the PLC 100 calculates the size of the monitor information stored in the storage 104 (step S202). The size information responder 105 then transmits a size information response including size information indicating the calculated size to the programming support device 200 (step S203).

For example, when receiving the size information request, the size information responder 105 calculates “X bytes” as the size of the monitor information in the first to tenth rows, the fourteenth to twentieth rows, and the twenty-fourth to thirty-third rows in the areas of the storage 104 illustrated in FIG. 4. The size information responder 105 then transmits a size information response including the size information indicating the calculated size to the programming support device 200.

When receiving the size information response from the size information responder 105, the monitor information acquirer 202 in the programming support device 200 compares the size indicated by the size information included in the size information response with the size of information that can be included in a single monitor information response to determine the number of times n (n is a natural number greater than or equal to 1) of transmission of a monitor information request to the PLC 100 (step S204). The monitor information acquirer 202 then transmits the monitor information request to the PLC 100 by the determined number of times of transmission (step S205). The monitor information request is for acquiring monitor information to be displayed on the screen and specifies a size of the monitor information to be included in the monitor information response.

When receiving the monitor information request from the monitor information acquirer 202, the monitor information responder 106 in the PLC 100 transmits a monitor information response including monitor information of the specified size to the programming support device 200 (step S206). Steps S205 and S206 are repeated by n number of times of transmission.

For example, when the size of information that can be included in a packet is set to “0.6X bytes” and the size information in the size information response indicates “X bytes”, the monitor information acquirer 202 determines that the number of times of transmission of a monitor information request is twice to acquire the monitor information to be displayed on the screen. The monitor information acquirer 202 then transmits the first monitor information request specifying a size of “0.6X bytes” to the PLC 100. When receiving the first monitor information request, the monitor information responder 106 transmits a first monitor information response including monitor information of the size specified in the first monitor information request to the programming support device 200. When receiving the first monitor information response, the monitor information acquirer 202 transmits the second monitor information request specifying a size of “0.4X bytes” to the PLC 100. When receiving the second monitor information request, the monitor information responder 106 transmits a second monitor information response including monitor information of the size specified in the second monitor information request to the programming support device 200. The monitor information acquirer 202 then receives the second monitor information response.

When receiving n monitor information responses from the monitor information acquirer 202, the display 203 in the programming support device 200 displays the monitor information included in the received monitor information responses on the screen (step S207).

For example, the display 203 displays information including the program execution time, the wait time, and the execution time of the end process as on the window 300 in FIG. 5 based on the monitor information acquired by the monitor information acquirer 202.

The structure according to the present embodiment visualizes the execution time of the end process performed each time execution of the program is completed. This facilitates identification of the cause of a trouble that may occur in the end process.

The structure according to the present embodiment can also measure the program execution time, the wait time, and the execution time of the end process for each core and visualize these times. This allows the user to optimize allocation of the program and the end process to each core and easily distribute the load. This may also allow the user to easily achieve consideration of shortening the scan time and identification of the cause of a trouble that may occur in executing a program created by the user.

The programming support device in the present embodiment can also specify the size of monitor information to be displayed on the screen to allow transmission of the monitor information of the specified size from the PLC. This minimizes the communication load between the programming support device and the PLC without involving transmission and reception of any unintended information other than monitor information to be displayed on the screen in the communication.

When the number of programs executed by the PLC changes as a result of writing programs while the control system is operating, monitor information acquired from the PLC may have the size exceeding the maximum size of a single packet. In the present embodiment, the programming support device determines information about the size of the monitor information before acquiring the monitor information, and acquires the monitor information with multiple packets when the size of the monitor information exceeds the size of a single packet. This allows flexible acquisition of monitor information when the number of programs executed changes.

### Modifications

Although the embodiment of the present disclosure is described above, various forms of variations and applications are possible in implementing the present disclosure.

In the above embodiment, the program execution time measurer 101 may further measure the execution time of an interrupt program included in the program. The display 203 may then display the execution time of the interrupt program on the screen. In this case, the storage 104 further stores information about the execution time of the interrupt program and the execution count of the interrupt program, and the monitor information includes information about the execution time of the interrupt program and the execution count of the interrupt program.

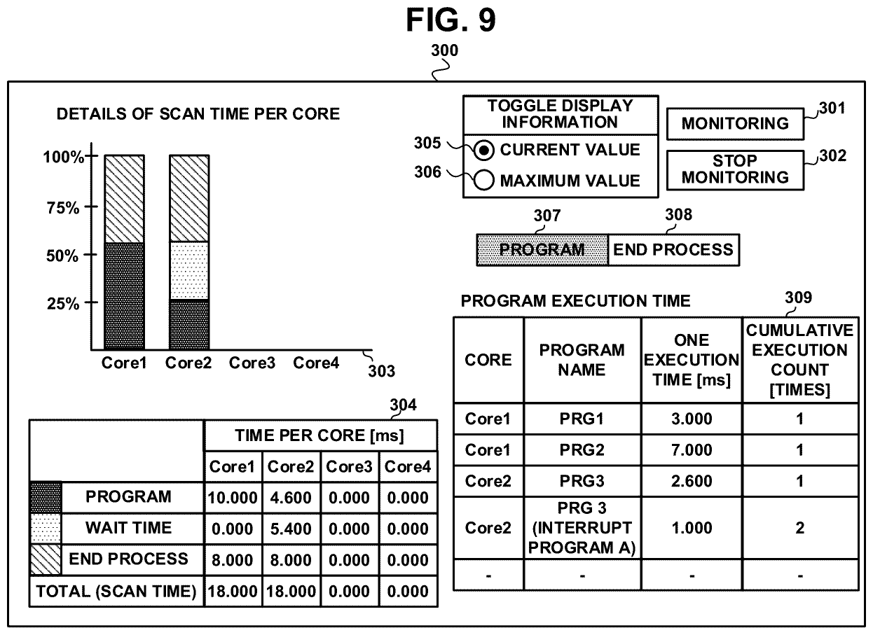

For example, “PRG3” executed by “Core 2” includes interrupt program A that is executed twice in “PRG3”. In this case, the program execution time measurer 101 measures the execution time of “interrupt program A”. As illustrated in the table 309 in FIG. 9, the display 203 displays, for “interrupt program A”, the execution time of “1.000 [ms]” and the cumulative execution count of “2 times”.

This structure allows the user designing an interrupt program to identify the degree by which the interrupt program can affect the scan time, thus facilitating the design of the interrupt program. In addition, when the interrupt program as designed increases the scan time, the user can easily identify the cause of such an increase in the scan time.

In the above embodiment, the monitor information is displayed on the screen in the programming support device 200, but the embodiment is not limited to this structure. The monitor information may be displayed on the screen in another device connected to the PLC 100 or on the screen in the PLC 100.

In addition, the operation program describing the operation of the PLC 100 and the programming support device 200 in the above embodiment may be used for an existing personal computer or an existing information terminal device to allow the personal computer or the information terminal device to function as the PLC 100 and the programming support device 200.

Such a program may be distributed in any manner. For example, the program may be distributed as being stored in a non-transitory computer-readable recording medium such as a compact disk read-only memory (CD-ROM), a digital versatile disc (DVD), or a memory card, or may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The control system, the programmable logic controller, the visualization method, and the program according to the embodiments of the present disclosure allow reference to the execution time of the end process performed each time execution of the program is completed.

### REFERENCE SIGNS LIST

1 Control system
11 Multi-core processor
12, 22 Main storage
13, 23 Auxiliary storage
14 First communicator
15 Second communicator
16, 27 Bus
21 Processor
24 Communicator
25 Input device
26 Output device
100 PLC (programmable logic controller)
101 Program execution time measurer
102 End process time measurer
103 Calculator
104 Storage
105 Size information responder
106 Monitor information responder
200 Programming support device
201 Size information acquirer
202 Monitor information acquirer
203 Display
300 Window
301, 302, 307, 308 Button
303 Bar graph
304, 309, 310 Table
305, 306 Radio button

1. A control system, comprising:
a programmable logic controller to execute at least one program, the programmable logic controller comprising first processing circuitry and a first storage; and
a programming support device to create the at least one program, the programming support device comprising second processing circuitry and a second storage, wherein
the first processing circuitry measures an execution time of an end process performed each time execution of each of the at least one program is completed;
the second processing circuitry displays the execution time of the end process on a screen included in the programming support device,
the first processing circuitry
executes a plurality of programs with a multi-core processor including a plurality of cores,
measures an execution time of a program executed by each of the plurality of cores,
calculates a wait time taken to cause the end process performed by each of the plurality of cores to start at a same timing, and
measures an execution time of the end process performed by each of the plurality of cores, and
the second processing circuitry displays the execution time of the program, the wait time, and the execution time of the end process on the screen for each of the plurality of cores.

2. The control system according to claim 1, wherein
content of the end process is set with the programming support device by a user who has created the at least one program.

3. (canceled)

4. The control system according to claim 1, wherein
the first processing circuitry further measures an execution time of an interrupt program included in the at least one program, and
the second processing circuitry displays the execution time of the interrupt program on the screen.

5. The control system according to claim 1, wherein
the first processing circuitry stores, into the first storage, monitor information including information about the execution time of the program, information about the execution time of the end process, and information about the wait time,
the second processing circuitry
transmits, to the programmable logic controller, a size information request to acquire size information indicating a size of the monitor information to be displayed on the screen, and
transmits, to the programmable logic controller, a monitor information request to acquire the monitor information to be displayed on the screen,
the first processing circuitry
determines, in response to the size information request, a size of the monitor information stored in the first storage and transmits a size information response including size information indicating the determined size to the programming support device, and
transmits, in response to the monitor information request, a monitor information response including the monitor information stored in the first storage to the programming support device,
the second processing circuitry compares the size indicated by the size information included in the transmitted size information response and a size of information to be included in one monitor information response to determine a number of times of transmission of the monitor information request to the programmable logic controller, and transmits, by the determined number of times, the monitor information request specifying a size of the monitor information to be included in the monitor information response,
the first processing circuitry transmits the monitor information response including the monitor information of the size specified in the monitor information request to the programming support device to transmit the monitor information in a divided manner to the programming support device, and
the second processing circuitry displays the monitor information included in the monitor information response on the screen.

6. A programmable logic controller for executing a plurality of programs with a multi-core processor including a plurality of cores, the programmable logic controller comprising:
processing circuitry; and
a storage, wherein
the processing circuitry
measures an execution time of a program executed by each of the plurality of cores,
measures an execution time of an end process performed by each of the plurality of cores each time execution of the program is completed,
calculates a wait time taken to cause the end process performed by each of the plurality of cores to start at a same timing,
stores, in the storage, monitor information including information about the execution time of the program, information about the execution time of the end process, and information about the wait time, and
transmits, in response to a monitor information request to acquire the monitor information to be displayed on a screen, a monitor information response including the monitor information stored in the storage.

7. (canceled)

8. A non-transitory computer-readable recording medium storing a program executable by a computer to execute a plurality of programs with a multi-core processor including a plurality of cores, the program causing the computer to execute processing comprising:
measuring an execution time of a program executed by each of the plurality of cores;
measuring an execution time of an end process performed by each of the plurality of cores each time execution of the program is completed;
calculating a wait time taken to cause the end process performed by each of the plurality of cores to start at a same timing;
storing monitor information including information about the execution time of the program, information about the execution time of the end process, and information about the wait time; and
transmitting, in response to a monitor information request to acquire the monitor information to be displayed on a screen, a monitor information response including the monitor information stored in the first storage.

9. The control system according to claim 2, wherein
the first processing circuitry stores, into the first storage, monitor information including information about the execution time of the program, information about the execution time of the end process, and information about the wait time,
the second processing circuitry
transmits, to the programmable logic controller, a size information request to acquire size information indicating a size of the monitor information to be displayed on the screen, and
transmits, to the programmable logic controller, a monitor information request to acquire the monitor information to be displayed on the screen,
the first processing circuitry
determines, in response to the size information request, a size of the monitor information stored in the first storage and transmitting a size information response including size information indicating the determined size to the programming support device, and
transmits, in response to the monitor information request, a monitor information response including the monitor information stored in the first storage to the programming support device,
the second processing circuitry compares the size indicated by the size information included in the transmitted size information response and a size of information to be included in one monitor information response to determine a number of times of transmission of the monitor information request to the programmable logic controller, and transmits, by the determined number of times, the monitor information request specifying a size of the monitor information to be included in the monitor information response,
the first processing circuitry transmits the monitor information response including the monitor information of the size specified in the monitor information request to the programming support device to transmit the monitor information in a divided manner to the programming support device, and
the second processing circuitry displays the monitor information included in the monitor information response on the screen.

10. The control system according to claim 4, wherein
the first processing circuitry stores, into the first storage, monitor information including information about the execution time of the program, information about the execution time of the end process, and information about the wait time,
the second processing circuitry
transmits, to the programmable logic controller, a size information request to acquire size information indicating a size of the monitor information to be displayed on the screen, and
transmits, to the programmable logic controller, a monitor information request to acquire the monitor information to be displayed on the screen,
the first processing circuitry
determines, in response to the size information request, a size of the monitor information stored in the first storage and transmitting a size information response including size information indicating the determined size to the programming support device, and
transmits, in response to the monitor information request, a monitor information response including the monitor information stored in the first storage to the programming support device,
the second processing circuitry compares the size indicated by the size information included in the transmitted size information response and a size of information to be included in one monitor information response to determine a number of times of transmission of the monitor information request to the programmable logic controller, and transmits, by the determined number of times, the monitor information request specifying a size of the monitor information to be included in the monitor information response,
the first processing circuitry transmits the monitor information response including the monitor information of the size specified in the monitor information request to the programming support device to transmit the monitor information in a divided manner to the programming support device, and
the second processing circuitry displays the monitor information included in the monitor information response on the screen.
